(19) United States
(12) Patent Application Publication
(10) Pub. No.: US 2026/0244008 A1
(43) Pub. Date: Aug. 20, 2026

(54) OPTICAL SYSTEM AND IMAGE PICKUP APPARATUS

(71) Applicant: CANON KABUSHIKI KAISHA, Tokyo (JP)

(72) Inventor: Mikio KOBAYASHI, Tochigi (JP)

(21) Appl. No.: 19/440,746

(22) Filed: Jan. 6, 2026

(30) Foreign Application Priority Data
Feb. 20, 2025 (JP) 2025-025589

(51) Int. Cl. G02B 17/08; G02B 5/30

(52) U.S. Cl. CPC G02B 17/0856; G02B 5/3083

(57) ABSTRACT

An optical system includes, in order, a first transmissive reflective surface, a first phase shifter, a second transmissive reflective surface, and a second phase shifter. Predetermined inequalities are satisfied.

### BACKGROUND

### Field of the Technology

The aspect of the disclosure relates to one or more embodiments of an optical system and an image pickup apparatus.

### Description of the Related Art

U.S. Pat. No. 9,798,115 and Japanese Patent Application Laid-Open No. 2011-081315 disclose methods for manufacturing an optical system used in an objective optical system for endoscopes and an imaging optical system for a head-mounted display (HMD) using a technology known as wafer-level optics.

A polarized light reflection imaging system combining a polarizer and a half-mirror, as disclosed in Japanese Patent Application Laid-Open No. 2005-352273, is used as a compact optical system.

### SUMMARY

One or more embodiments of an optical system according to one or more aspects of the disclosure may include, in order, a first transmissive reflective surface, a first phase shifter, a second transmissive reflective surface, and a second phase shifter. The following inequalities are satisfied:

$$\vert Y / Rh 1 \vert \leq 020$$

$$\vert Y / Rr 1 \vert \leq 0.2$$

$$\vert Y / Rr 2 \vert \leq 0.2$$

where Rh1 is a radius of curvature on an optical axis of the first transmissive reflective surface, Rr1 is a radius of curvature on the optical axis of a surface on which the first phase shifter is provided, and Rr2 is a radius of curvature on the optical axis of a surface on which the second phase shifter is provided. An image pickup apparatus having the above optical system also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of an optical system according to Example 1.

FIG. 2 is an aberration diagram of the optical system according to Example 1.

FIG. 3 is a sectional view of an optical system according to Example 2.

FIG. 4 is an aberration diagram of the optical system according to Example 2.

FIG. 5 is a sectional view of an optical system according to Example 3.

FIG. 6 is an aberration diagram of the optical system according to Example 3.

FIG. 7 is a sectional view of an optical system according to Example 4.

FIG. 8 is an aberration diagram of the optical system according to Example 4.

FIG. 9 is a sectional view of an optical system according to Example 5.

FIG. 10 is an aberration diagram of the optical system according to Example 5.

FIG. 11 is a sectional view of an optical system according to Example 6.

FIG. 12 is an aberration diagram of the optical system according to Example 6.

FIG. 13 is a sectional view of an optical system according to Example 7.

FIG. 14 is an aberration diagram of the optical system according to Example 7.

FIG. 15 is a sectional view of an optical system according to Example 8.

FIG. 16 is an aberration diagram of the optical system according to Example 8.

FIG. 17 is a schematic diagram illustrating an optical path of the optical system.

FIG. 18 is a schematic diagram illustrating an optical path of another optical system.

FIG. 19 is a schematic diagram of an image pickup apparatus having any one of the optical systems according to Examples 1 to 8.

FIG. 20 is a schematic diagram of another image pickup apparatus having any one of the optical systems according to Examples 1 to 8.

### DESCRIPTION OF THE EMBODIMENTS

Referring now to the accompanying drawings, a description will be given of examples according to the disclosure.

An optical system according to each example is an optical system obtained using wafer-level optics. Wafer-level optics is a wafer process in which multiple lenses are created on a wafer using semiconductor manufacturing technology, and a plurality of wafers (planar substrates) are stacked and bonded together, then cut to manufacture multiple optical systems at once. Optical systems manufactured using wafer-level optics are called wafer-level lenses, and image pickup apparatuses that use wafer-level lenses as their imaging optical systems are called wafer-level cameras.

The optical system according to each example is used in conjunction with a display optical system such as viewfinders and an HMD for line of sight detection and external world imaging. It is also used in cameras built into electronic apparatuses such as mobile phones, smartphones, and wearable devices, as well as in objective optical systems for endoscopes.

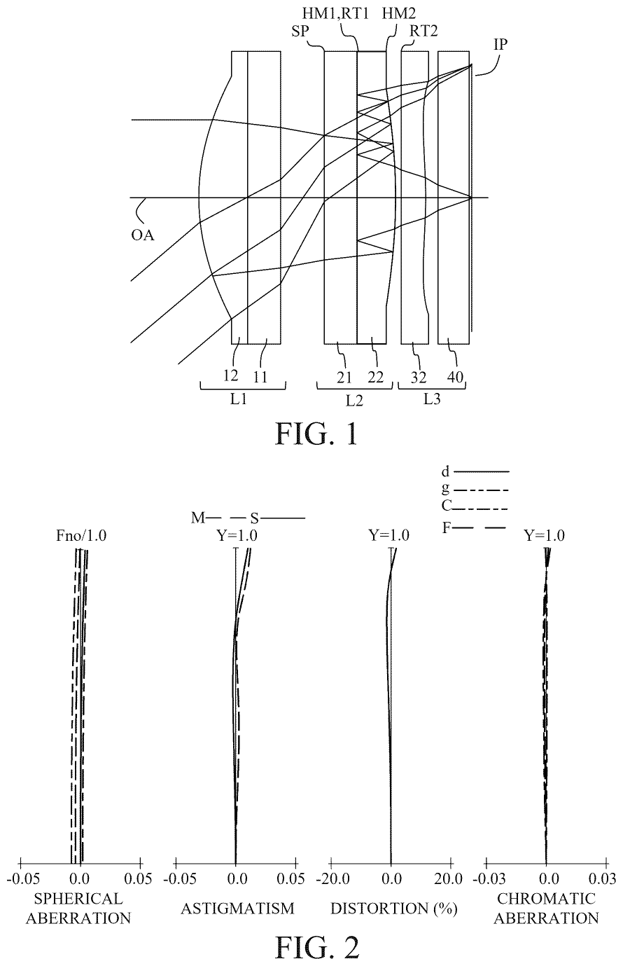

FIGS. 1, 3, 5, 7, 9, 11, 13, and 15 illustrate cross sections of the optical systems (wafer-level lenses) according to Examples 1 to 8. In each sectional view, the left side is the object side (front side), and the right side is the image side (rear side). SP is an aperture stop, and IP is an image plane. A photosensitive surface corresponding to an imaging surface of an image sensor such as a CCD sensor or CMOS sensor in an image pickup apparatus, or a film surface of a film-based camera, is disposed on the image plane IP. OA is an optical axis of the optical system. A direction in which the optical axis OA extends is called an optical axis direction.

The optical system according to each example includes the aperture stop SP. The optical system further includes, in order in the optical axis direction, a first transmissive reflective surface HM1, a first phase shifter RT1, a second transmissive reflective surface HM2, and a second phase shifter RT2. The optical system according to each example further includes, in order from the object side to the image side, a first lens unit L1, a second lens unit L2, and a third lens unit L3, or the first lens unit L1 and the second lens unit L2. One of the first to third lens units L1 to L3 includes the aperture stop SP, the first transmissive reflective surface HM1, the first phase shifter RT1, the second transmissive reflective surface HM2, and the second phase shifter RT2.

The optical system according to each example has no lens unit that moves for focusing.

While the optical system according to each example includes three or two lens units, it may have four or more units. A cover glass such as a parallel plate may also be disposed closer to the object than the lens unit closest to the object, and closer to the image plane than the lens unit closest to the image plane.

The first to third lens units L1 to L3 are manufactured using a wafer process. More specifically, they are manufactured by forming a lens layer made of a curable resin material on a wafer made of a glass material, or by pouring curable resin between two opposing molds to form a wafer in which the substrate and lenses are integrally molded. A large number of wafer-level lenses can be manufactured by arranging the lens unit and the image sensor cover glass at a distance from each other, bonding them together outside the effective area through which light rays contributing to imaging pass, and then cutting them. The material forming the lens layer can be a thermoplastic resin or an ultraviolet-curable resin, as long as it is a curable resin. Examples include acrylic resin, silicone resin, and cycloolefin polymer.

The aperture stop SP can be formed by depositing a light-shielding film such as chromium using a mask, or by forming an opening by etching after deposition. In this case, forming the aperture stop SP on a flat surface such as a substrate makes it easier to control the mask placement in the thickness direction, which is suitable for a manufacturing perspective.

In an optical system according to one example, light incident from the object side transmits through the first transmissive reflective surface HM1 and the first phase shifter RT1 in this order, and is reflected by the second transmissive reflective surface HM. The light then transmits through the first phase shifter RT1, is reflected on the first transmissive reflective surface HM1, transmits through the first phase shifter RT1, the second transmissive reflective surface HM2, and the second phase shifter RT2 in that order, and then reaches the image plane IP.

In an optical system according to another example, light incident from the object side transmits through the second phase shifter RT2, the second transmissive reflective surface HM2, and the first phase shifter RT1 in that order, and is reflected on the second transmissive reflective surface HM2. The light then transmits through the first phase shifter RT1 and is reflected by the second transmissive reflective surface HM2, transmits through the first phase shifter RT1 and the first transmissive reflective surface HM1 in that order, and then reaches the image plane IP.

The first transmissive reflective surface HM1 and the second transmissive reflective surface HM2 do not necessarily have to have a transmittance and a reflectance of 50%. The ratio of transmittance to reflectance for randomly polarized light may be in the range of 1:3 to 3:1. Randomly polarized light is light with Stokes parameters S0=1, S1=S2=S3=0. The first transmissive reflective surface HM1 and the second transmissive reflective surface HM2 may also be absorptive. Lenses may be formed or bonded to either or both sides of each transmissive reflective surface.

A Faraday rotator or a quarter-wave plate (QWP) can be used as a phase shifter. Each example uses a QWP as the phase shifter. For example, a birefringent polymer film or liquid crystal alignment layer can be used as the QWP. A laminate of such polymer films or liquid crystal alignment layers can also be used. Properly laminating the layers can provide a phase difference approaching one-quarter of the wavelength over a wide wavelength range. For example, the “WA-140T” manufactured by Nippon Kayaku Co., Ltd. or the “Polar Correct” manufactured by Colorlink Japan Co., Ltd. can be used. In addition to the above, inorganic wave plates manufactured by Dexerials Corporation can also be used as the QWP.

The QWP may be bonded to the first transmissive reflective surface HM1 or the second transmissive reflective surface HM2, or may be disposed separately from these transmissive reflective surfaces. The QWP may be inserted into the optical path as a film, or a film bonded to a glass plate may be inserted into the optical path. Lenses may also be formed or bonded to one or both sides of the QWP. For example, lenses can be formed on one or both sides of the inorganic wave plate using wafer-level optics with the inorganic wave plate as the substrate.

The characteristics of the optical system according to each example will be described below. As discussed above, the optical system according to each example is wafer-level optics, and compactness is important for its application. Reducing the number of wafers is also necessary to reduce costs. Thus, the optical system according to each example uses a polarized light reflection imaging system.

### Polarization-Utilization Configuration 1

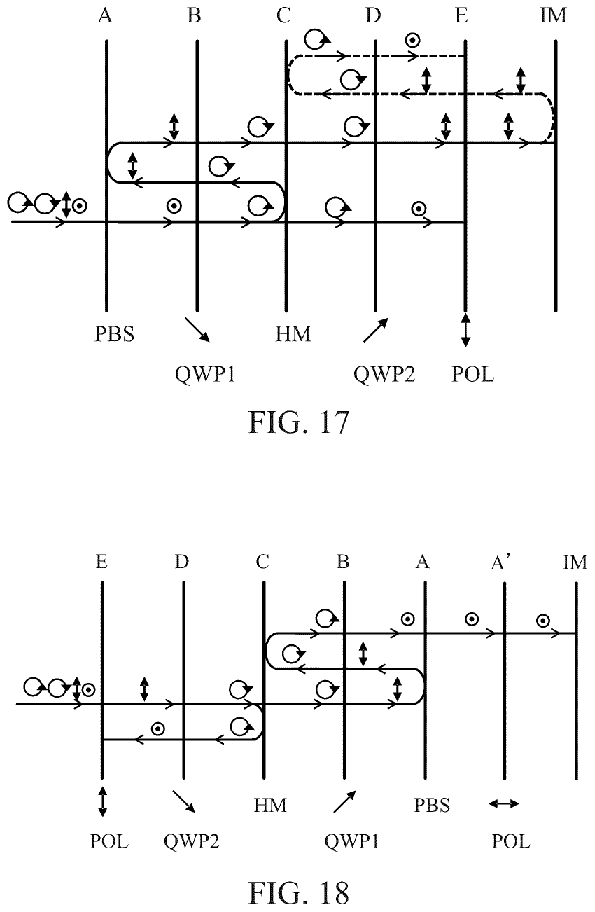

FIG. 17 illustrates the utilization of polarization in an optical system that includes, from the object side (left side of the figure) toward the image (imaging surface IM) side, a polarization-selective transmissive reflective element PBS:A as a first transmissive reflective surface, a first quarter-wave plate QWP1:B, a half-mirror HM:C as a second transmissive reflective surface, a second quarter-wave plate QWP2:D, and a linear polarizer POL:E.

The PBS is configured to reflect linearly polarized light having the same polarization direction as that of the linearly polarized light that has transmitted through the linear polarizer POL, and to transmit linearly polarized light having a polarization direction orthogonal to it. The PBS is a wire-grid polarizer or a reflection-type polarizer of a retardation-film laminated type. The wire-grid forming surface or the retardation-film surface of the PBS functions as the transmissive reflective surface. The wire-grid polarizer does not necessarily require metal wires aligned in parallel; any optical member having thin metal or dielectric layers disposed at predetermined intervals and functioning as a transmissive reflective element may be used, such as elements produced by depositing aligned metal or dielectric layers.

The QWP1 and QWP2 are arranged such that their slow axes are tilted by 45° relative to the transmission axis of the POL. The QWP1 and QWP2 may be arranged such that their slow axes differ by 90°. Due to this arrangement, when light passes through the QWP1 and QWP2, the wavelength-dispersion characteristics of the waveplates cancel each other.

The HM is a half-mirror formed, for example, by a dielectric multilayer film or metallic deposition, and functions as a transmissive reflective surface. The POL is an absorptive linear polarizer, for example.

Among the light incident on the optical system from the object side, the linearly polarized light that has transmitted through the PBS is converted into circularly polarized light by the QWP1. This circularly polarized light enters the HM, where a part is reflected and becomes circularly polarized light in the reverse rotation direction, which returns to the QWP1. The returned circularly polarized light is converted by the QWP1 into linearly polarized light whose polarization direction is orthogonal to that of the linearly polarized light that has previously transmitted through the PBS. This linearly polarized light returns to the PBS and is reflected.

The circularly polarized light that has transmitted through the HM is converted by the QWP2 into linearly polarized light having the same polarization direction as that of the linearly polarized light that has transmitted through the PBS, and this light is absorbed by the POL.

The linearly polarized light reflected by the PBS is converted by the QWP1 into circularly polarized light, which enters the HM. A part of the circularly polarized light incident on the HM transmits through it and enters the QWP2, where it is converted into linearly polarized light having the same polarization direction as that of the linearly polarized light reflected by the PBS. The linearly polarized light emitted from the QWP2 enters the POL. Since the polarization direction of the incident linearly polarized light coincides with the transmission axis of the POL, most of the light passes through the POL and reaches the IM.

Due to the polarization-utilization configuration described above, among the light incident on the optical system, only the light that passes through the PBS, is reflected by the HM, is reflected by the PBS, and transmits through the HM reaches the IM.

In a case where a cholesteric liquid crystal is used instead of the HM as the second transmissive reflective surface, the cholesteric liquid crystal may be disposed such that it strongly reflects the circularly polarized light incident during the first reflection. Thereby, the light amount in the normal light path can be increased while ghost light is reduced.

In an image sensor, such as a CCD sensor and a CMOS sensor, the reflectance of the imaging surface is generally high. Thus, light reflected by the IM passes again through the POL and is converted into circularly polarized light by the QWP2. Thereafter, the circularly polarized light is reflected by the HM, becomes circularly polarized light of in the reverse rotation direction, and enters the QWP2 again. The circularly polarized light in the reverse rotation direction is converted by the QWP2 into linearly polarized light whose polarization direction is orthogonal to that of the linearly polarized light that has transmitted through the POL just before. This linearly polarized light enters the POL. Since the polarization direction is orthogonal to the transmission axis of the POL, most of the light is absorbed by the POL.

Thus, light reflected by the IM and HM is almost completely removed, and ghost and flare are less noticeable. To obtain such a reflection-reduction effect, no optical low-pass filter using birefringence may be present between IM and POL. This is because an optical low-pass filter would shift the polarization state from the linearly polarized light state.

In this configuration, a quarter-wave plate may be disposed between the polarization-selective transmissive reflective element A and the object. The quarter-wave plate is disposed so that its fast or slow axis forms an angle of 45° relative to the transmission axis of the polarization-selective transmissive reflective element A. This pseudo-depolarization allows imaging to be performed regardless of the polarization direction, even if the light incident from the object side is linearly polarized. A depolarizer may also be placed instead of the quarter-wave plate. For example, Toyobo Co., Ltd.'s “Cosmoshine SRF” can be used as a depolarizer. Cosmoshine SRF is a film with a large birefringence of around 10,000 nm. Using such a film can sometimes prevent color unevenness caused by the wavelength and angle characteristics of the wave plate compared to when a quarter-wave plate is used.

In this configuration, a quarter-wave plate may be disposed between the PBS and the object. In such a case, the quarter-wave plate is disposed so that its fast axis or slow axis forms an angle of 45° relative to the transmission axis of the PBS. Thereby, the polarization state is pseudo-randomized, and even when the light incident from the object is linearly polarized light, imaging can be performed regardless of the polarization direction. A depolarizer may be used instead of the quarter-wave plate. As the depolarizer, “Cosmoshine SRF” manufactured by Toyobo Co., Ltd. may be used. Cosmoshine SRF is a film having a large birefringence of approximately 10,000 nm, and the use of such a film is expected to suppress color non-uniformity caused by the wavelength and angle characteristics of a quarter-wave plate.

### Polarization-Utilization Configuration 2

FIG. 18 illustrates the utilization of polarization in an optical system that includes, in order from the object side toward the image (imaging surface IM) side, a first linear polarizer POL1:E, a second quarter-wave plate QWP2:D, a half-mirror HM:C serving as a second transmissive reflective surface, a first quarter-wave plate QWP1:B, and a polarization-selective transmissive reflective element PBS:A as a first transmissive reflective surface. The arrangement, optical-axis orientation, and configurations of the polarization-selective transmissive reflective element, the quarter-wave plate, and the linear polarizer are similar to those in Polarization-Utilization Configuration 1.

Of the light incident on the optical system from the object side, the linearly polarized light that has transmitted through the POL1 is converted into circularly polarized light by the QWP2. The circularly polarized light enters the HM, a part of which is reflected, becomes circularly polarized light in the reverse rotation direction, and returns to the QWP2. The circularly polarized light in the reverse rotation direction returning to the QWP2 is converted by the QWP2 into linearly polarized light whose polarization direction is orthogonal to that of the linearly polarized light that has previously transmitted through the POL1, and the linearly polarized light is absorbed by the POL1.

On the other hand, the circularly polarized light that has transmitted through the HM is converted by the QWP1 into linearly polarized light having the same polarization direction as that of the linearly polarized light that has previously transmitted through the POL1, and enters the PBS. The linearly polarized light is reflected by the PBS and returns to the QWP1. The linearly polarized light returning to the QWP1 is converted into circularly polarized light, and a part of the circularly polarized light is reflected by the HM, becomes circularly polarized light in the reverse rotation direction, and enters the QWP1 again. The circularly polarized light in the reverse rotation direction entering QWP1 is converted into linearly polarized light whose polarization direction is orthogonal to that of the linearly polarized light previously reflected by the PBS. This linearly polarized light transmits through the PBS and reaches the IM.

Due to the polarization-utilization configuration described above, only light among light incident on the optical system, which transmits through the HM, is reflected by the PBS, is reflected by the HM, and transmits through PBS, reaches IM.

In this configuration, a second linear polarizer POL2:A′ may be disposed between the PBS and the IM. At this time, the direction of the transmission axis of the POL2 is matched with that of the PBS. Thereby, light that would be ghost or flare can be absorbed, because light is reflected by the IM, is reflected by the PBS, and again enters the IM.

In this configuration, a quarter-wave plate may be disposed between the POL1 and the object. In this case, the quarter-wave plate is disposed so that its fast axis or slow axis forms an angle of 45° relative to the transmission axis of the POL1. This enables imaging regardless of the polarization direction even when the incident light from the object is linearly polarized light. Instead of the quarter-wave plate, the depolarizer described in Polarization-Utilization Configuration 1 may be used.

In the description of the above two polarization-utilization configurations, the expressions “orthogonal,” “same (parallel),” and “45°” have been used. These expressions do not indicate exact angles of 90°, 0°, and 45°, respectively. Any angle within ±5°, ±2°, or ±1° of these angles may be used.

In the above two polarization-utilization configurations, the same quarter-wave plate may be used for the QWP1 and the QWP2. If the quarter-wave plates were ideal (i.e., strictly providing a quarter-wavelength phase shift for all wavelengths used and incident angles), different quarter-wave plates may be used. In the above two polarization-utilization configurations, the phases imparted by the QWP1 and the QWP2 when light passes through them cancel each other, allowing only specific light rays to be emitted toward the image side. That is, light that is reflected once at the PBS and once at the HM is emitted toward the image side, while light that has never been reflected at all and light reflected twice are absorbed by the linear polarizer. If the characteristics of the QWP1 and the QWP2 differ from one another, unintended light is emitted toward the image side, increasing ghost and flare.

In the above two polarization-utilization configurations, an image sensor including an optical low-pass filter may be used. In such a case, the relative angle between the transmission axis of the linear polarizer closest to the image plane and the fast axis of the birefringent plate closest to the object among the birefringent plates constituting the optical low-pass filter may be 45° or 135°. Thereby, a similar low-pass effect to that of an ordinary refractive optical system with almost no polarization dependence may be acquired. Furthermore, a quarter-wave plate may be disposed on the image side of the linear polarizer closest to the image plane. In this case, the relative angle between the fast axis of the quarter-wave plate and the transmission axis of the linear polarizer closest to the image plane may be 45° or 135°. Thereby, a low-pass effect similar to that of a typical optical system may be acquired by emitting circularly polarized light toward the image sensor. Pseudo-randomly polarized light of the emitted light may be formed by placing a plastic molded lens having large birefringence on the image side of the linear polarizer closest to the image plane, thereby providing a low-pass effect similar to that of a conventional optical system.

In the two polarization-utilization configurations described above, the polarization-selective transmissive reflective element, the quarter-wave plate, and the linear polarizer may be circular or rectangular. In a case where film-like polarizing elements primarily made of polymer materials are used, sufficient surface precision may be secured by bonding them to, for example, a glass or resin plate, as described above. By bonding a large-format film to a glass or resin plate and then cutting out a rectangular or other shape from it, material waste can be reduced. In the two polarization-utilization configurations described above, the azimuth relationship between the polarizing elements is important, as described above. Using rectangular polarizing elements makes it easier to ensure the outer shape and element orientation (fast axis/slow axis, transmission axis/absorption axis, transmission axis/reflection axis) of each component can simplify or eliminate the need for azimuth adjustment. Instead of being perfectly rectangular, polarizing elements may have a notch or orientation flat for azimuth alignment in a part of the polarizing element.

Next, a description will be given of the configuration and conditions that the optical system in each example may satisfy. To configure a polarized-light reflection imaging system using wafer-level optics, as discussed above, a polarization-selective transmissive reflective element, a phase shifter, a half-mirror, and a phase shifter may be disposed in order along the optical axis direction. The polarization-selective transmissive reflective element may use a wire-grid polarizer or a retardation film laminate element. Forming a wire-grid polarizer or a retardation film laminate element on a surface with a large curvature is difficult to manufacture. In particular, in wafer processes, a plurality of optical surfaces are arranged on a single wafer, and a large curvature of the optical surface will result in a minute uneven structure within the wafer surface. In this case, molding stability deteriorates when films are laminated or the wire-grid structure is molded.

Similarly, the phase shifter may use a quarter-wave plate. In this case, even for quarter-wave plates, a process of bonding a film-like element to the optical surface of the substrate may be used in terms of ease of manufacturing, but manufacturing stability deteriorates if the optical surface has a large curvature.

On the other hand, for the transmissive reflective surface on which the half-mirror is formed, multilayer films formed by vapor deposition of inorganic dielectrics or films formed by vapor deposition of metal absorbing materials are used. These vapor deposition processes can also be used in wafer-level optics, and can form films even on optical surfaces with large curvatures.

For these reasons, the optical system according to each example may satisfy the following inequalities (1) to (3):

$$\vert Y / Rh 1 \vert \leq 020 \qquad ( 1 )$$

$$\vert Y / Rr 1 \vert \leq 0.2 \qquad ( 2 )$$

$$\vert Y / Rr 2 \vert \leq 0.2 \qquad ( 3 )$$

where Rh1 is a radius of curvature on the optical axis of the first transmissive reflective surface, Rr1 is a radius of curvature on the optical axis of the surface on which the first phase shifter is formed, Rr2 is a radius of curvature on the optical axis of the surface on which the second phase shifter is formed, and Y is a maximum image height of the optical system.

The maximum image height is the maximum height from the optical axis at an image position on the image plane (evaluation surface) and corresponds to a radius of an image circle formed by the optical system. While the first transmissive reflective surface may be aspherical, a spherical or flat surface may be used for ease of manufacturing.

From a manufacturing perspective, the values of inequalities (1) to (3) may be 0, i.e., the phase shifter may be flat. Since wafer-level optics is an optical system including a small number of lenses and a limited number of wafers, increasing the number of curved surfaces is expected to improve imaging performance in terms of aberration correction. The upper limits of inequalities (1) to (3) represent the range that can be manufactured using wafer processing. In a case where the value of each inequality becomes higher than the upper limit, it would be impossible to ensure uniformity within the wafer during forming of the transmissive reflective film and phase shifter (e.g., a quarter-wave plate).

The upper limits of inequalities (1) to (3) may be set to 0.18, 0.15, 0.12, or 0.10.

Polarized-light reflection imaging systems use a transmissive reflective surface, which in principle reduces the light amount. As a result, it is important to secure the light amount by reducing the F-number of the optical system, that is, by increasing the pupil diameter. However, increasing the pupil diameter increases the size of the optical system. To reduce the size of wafer-level optics, it is necessary not only to reduce the length of the optical system along the optical axis, but also to reduce its radial size. In the polarized-light reflection imaging system in particular, the height of an off-axis light beam from the optical axis increases with each reflection. In wafer-level optics that constitute a polarized-light reflection imaging system, the radial size of the optical system can be reduced by properly setting the relationship between a pupil diameter and an image height.

More specifically, the following inequality (4) may be satisfied:

$$0.3 \leq ( FNo \times Y ) / f \leq 1.75 \qquad ( 4 )$$

where FNo is an F-number of the optical system, and f is a focal length of the optical system.

In a case where (FNo×Y)/f becomes lower than the lower limit of inequality (4), it becomes difficult to correct an off-axis aberration such as astigmatism, and the overall length of the optical system increases. In a case where (FNo×Y)/f becomes higher than the upper limit of inequality (4), the image height relative to the pupil diameter increases, which increases the maximum diameter of the optical system.

The lower limit of inequality (4) may be set to 0.35, 0.40, 0.45, 0.50, or 0.55. The upper limit of inequality (4) may be set to 1.70, 1.65, 1.60, 1.55, or 1.50.

In order to minimize the size of wafer-level optics, the aperture stop may be disposed closer to the image plane than the surface closest to the object in the optical system. Placing the aperture stop close to the object, especially outside of the surface closest to the object in the optical system, increases the ray height of the off-axis light beam near the image plane, resulting in a radially larger optical system.

More specifically, the following inequality (5) may be satisfied:

$$0.2 \leq Lsp / L \leq 1.5 \qquad ( 5 )$$

where Lsp is a distance on the optical axis from the aperture stop to the image plane, and L is a distance on the optical axis from the optical surface closest to the object in the optical system to the image plane (overall optical length).

In a case where Lsp/L becomes lower than the lower limit of inequality (5), the aperture stop will be closer to the image plane, increasing the maximum diameter of the off-axis light beams on the object side. This makes aberration correction difficult and increases the size of the optical system. In a case where Lsp/L becomes higher than the upper limit of inequality (5), the aperture stop will be disposed closer to the object, increasing the ray height of the off-axis light beam near the image plane, resulting in a radially larger optical system.

The lower limit of inequality (5) may be set to 0.25, 0.3, or 0.35. The upper limit of inequality (5) may be set to 1.4, 1.3, 1.2, 1.1, 1.0, or 0.95.

In the optical system according to each example, the first transmissive reflective surface and the first phase shifter can be formed on the same surface. On the other hand, if a half-mirror is used as the second transmissive reflective surface, the second transmissive reflective surface may have a curved shape. Thus, the second phase shifter may have a smaller curvature than the second transmissive reflective surface and be formed on a different surface from the second transmissive reflective surface, in particular on a different optical member from the second transmissive reflective surface.

In a case where the second phase shifter is provided on a lens surface that does not include the first transmissive reflective surface or the second transmissive reflective surface, the following inequality (6) may be satisfied:

$$0 \leq θ m \leq 15 \qquad ( 6 )$$

where θm (deg) is a maximum angle of the normal to the lens surface on which the second phase shifter is formed relative to the optical axis.

The lower limit of inequality (6) means that the surface on which the second phase shifter is formed is flat. The second phase shifter may be formed on a flat surface, as it increases manufacturability. In a case where θm becomes higher than the upper limit of inequality (6), it becomes difficult to ensure uniformity within the wafer in forming the second phase shifter.

The upper limit of inequality (6) may be set to 14, 13, 12, 11, or 10.

For the optical system according to each example, the following inequality (7) may be satisfied:

$$2 \leq Nc \leq 7 \qquad ( 7 )$$

where Nc is the number of lens surfaces with power.

Ensuring that the lens surfaces with power fall within the range of inequality (7) can reduce the overall optical length of the optical system while effectively correcting a variety of aberrations.

The upper limit of inequality (7) may be set to 6, 5, or 4.

In the optical system according to each example, stacking the first transmissive reflective surface and the first phase shifter on top of each other can construct a polarized-light reflection imaging system without increasing the number of optical components.

Wafer-level optics are often used in applications with relatively large angles of view. Applying a polarized-light reflection imaging system to an optical system from a standard angle of view to a wide angle of view can place the aperture stop closer to the object than the first transmissive reflective surface and the second transmissive reflective surface. This allows for effective correction of aberrations such as astigmatism caused by the reflective surfaces in the area where off-axis light beams separate on the image side of the aperture stop, thereby achieving aberration correction and a reduced overall optical length of the optical system.

In the optical system according to each example, the size of the optical system can be reduced by properly setting a distance between the two transmissive reflective surfaces and the aperture stop. More specifically, the following inequality (8) may be satisfied:

$$0.10 \leq LS 1 / L \leq 0.75 \qquad ( 8 )$$

where LS1 is a distance on the optical axis between the aperture stop and one of the first and second transmissive reflective surfaces, which is closer to the image plane.

In a case where LS1/L becomes lower than the lower limit of inequality (8), the ray height at which two off-axis light beams pass through the reflective surface becomes too low, and astigmatism correction becomes difficult. In a case where LS1/L becomes higher than the upper limit of inequality (8), the ray height at which two off-axis light beams pass through the reflective surface becomes too high, and the maximum diameter of the optical system increases.

The lower limit of inequality (8) may be set to 0.15, 0.20, or 0.25. The upper limit of inequality (8) may be set to 0.70, 0.65, 0.60, or 0.55.

The aperture stop in wafer-level optics can be formed on either a flat or curved surface, but it may be formed on a flat surface because it reduces the impact of aberration fluctuations due to misalignment caused by manufacturing errors in the aperture stop.

In the optical system according to each example, good aberration correction is achieved by providing a large curvature to the transmissive reflective surface serving as a half-mirror. Since chromatic aberration does not occur on reflective surfaces and astigmatism is easily corrected, it is important to properly set the curvature of the transmissive reflective surface serving as a half-mirror. More specifically, the following inequality (9) may be satisfied:

$$1.5 \leq \vert Rhm / f \vert \leq 10. \qquad ( 9 )$$

where Rhm is a radius of curvature of transmission and reflection of the first transmissive reflective surface or the second transmissive reflective surface with the smaller radius of curvature on the optical axis.

In a case where |Rhm/f| becomes lower than the lower limit of inequality (9), the curvature of the reflective surface becomes too large, disrupting the balance between spherical aberration and astigmatism correction. In a case where |Rhm/f| becomes higher than the upper limit of inequality (9), a correction amount of astigmatism decreases, making it difficult to correct the various aberrations in the optical system.

The lower limit of inequality (9) may be set to 2.0, 2.5, or 3.0. The upper limit of inequality (9) may be set to 9.0, 8.0, 7.0, 6.0, or 5.5.

As illustrated in inequalities (1) to (3), the first transmissive reflective surface, the first phase shifter, and the second phase shifter used in each example optical system may have small curvatures. The phase shifter, such as a transmissive reflective element and a quarter-wave plate, is formed by laminating films or molding them using a mold, but the manufacturing process may involve the application of pressure or heat. In this case, even a slight curvature may reduce manufacturing stability. In particular, when forming the phase shifter by stacking two optical members, manufacturing stability may be improved by making the shape of the stacking surfaces flat.

In the optical system according to each example, the effective area of at least one surface of the optical member disposed between the optical member closest to the object and the optical member closest to the image plane may be flat. This improves manufacturing stability.

In the optical system according to each example, the phase shifter can also be formed on a surface with a small curvature, such as the surface of the cover glass of the image sensor. However, the image sensor may get damaged due to pressure, heat, etc. during the process of forming the quarter-wave plate on the cover glass of the image sensor. Hence, the phase shifter may be provided on an optical member separate from the cover glass of the image sensor. Furthermore, if dust or other foreign matter remains on the phase shifter or if foreign matter or unevenness remains inside the phase shifter during the process of forming the phase shifter on the substrate, and the phase shifter is close to the image sensor, the dust, foreign matter, or unevenness may be reflected in the image captured by imaging.

Thus, the following inequality (10) may be satisfied:

$$0.05 \leq Lf / ( f \times FNo ) \leq 1.5 \qquad ( 10 )$$

where Lf is a distance on the optical axis between the image plane and one of the first and second phase shifters, which is closer to the image plane.

In a case where Lf/(f×FNo) becomes lower than the lower limit of inequality (10), the phase shifter and image sensor become too close, and it becomes easier for foreign objects to appear in the image. In a case where Lf/(f×FNo) becomes higher than the upper limit of inequality (10), the back focus of the optical system and the overall optical length of the optical system increase, and the size reduction becomes difficult.

The lower limit of inequality (10) may be set to 0.06, 0.07, 0.08, 0.09, 1.00, 1.10, or 0.12. The upper limit of inequality (10) may be set to 1.40, 1.30, 1.20, 1.10, or 1.05.

In the optical system according to each example, the F-number (FNo) of the optical system may satisfy the following inequality (11):

$$0.7 \leq FNo \leq 2.8 \qquad ( 11 )$$

In a case where FNo becomes lower than the lower limit of inequality (11), it becomes difficult to correct a variety of aberrations, such as spherical aberration, as the aperture diameter increases. In a case where FNo becomes higher than the upper limit of inequality (11), the transmitting light amount through the optical system decreases. In principle, the polarized-light reflection imaging system reduces the light amount by ¼ or ⅛, and it becomes difficult to ensure sufficient light for endoscopy or line-of-sight detection.

The lower limit of inequality (11) may be set to 0.8, 0.9, or 0.95. The upper limit of inequality (11) may be set to 2.5, 2.0, 1.8, 1.6, or 1.5.

In the optical system according to each example, properly setting a distance between the two reflective surfaces can achieve both aberration correction and size reduction, particularly in terms of radial size. More specifically, the following inequality (12) may be satisfied:

$$0.05 \leq Lhm / L \leq 0.45 \qquad ( 12 )$$

where Lhm is a distance on the optical axis between the first transmissive reflective surface and the second transmissive reflective surface.

In a case where Lhm becomes lower than the lower limit of inequality (12), the distance between the two reflective surfaces becomes too close, and aberrations on the reflective surfaces cannot be properly corrected. In a case where Lhm becomes higher than the upper limit of inequality (12), the ray height of the off-axial light beam on the reflective surface increases, which either increases the radial size of the optical system or makes it difficult to increase the power of the reflective surface, making good aberration correction difficult.

The lower limit of inequality (12) may be set to 0.06, 0.07, 0.08, 0.09, or 0.10. The upper limit of inequality (12) may be set to 0.40, 0.35, 0.30, or 0.27.

In the optical system according to each example, which is wafer-level optics, wiring is often formed using a process involving high temperatures such as reflow after the optical system and image sensor are laminated. Thus, the resin material used to form each lens is ideally one that can withstand thermal curing and UV curing processes and can withstand high heat temperatures after the lens is formed. Accordingly, in the optical system according to each example, the following inequality (13) may be satisfied:

$$1.5 \leq NL \leq 1.8 \qquad ( 13 )$$

where NL is a refractive index for the d-line of the resin material that can withstand reflow etc. and is used for the curved optical components.

In a case where NL becomes lower than the lower limit of inequality (13), the material will be difficult to support reflow. In a case where NL becomes higher than the upper limit of inequality (13), it is difficult to ensure transparency in thermosetting or UV-curable resins, or the material will become highly dispersed, resulting in increased chromatic aberration.

The upper limit of (13) may be set to 1.75, 1.7, or 1.65.

Wafer-level optics, such as the optical systems in each example, are typically manufactured by stacking wafers using spacers or other devices outside the effective area of each lens. Since wafer processes mold multiple lenses at once, higher stability is required than that for lens molding processes in which lenses are molded one at a time. Furthermore, phase shifters, such as quarter-wave plates, used in the polarized-light reflection imaging systems in each example require a process in which they are molded on the entire wafer at once. Therefore, by properly setting the width of the outer circumferential area of the effective area in the lens where the phase shifter is formed, it is possible to achieve both miniaturization and a stable manufacturing process.

More specifically, the following inequality (14) may be satisfied:

$$0.1 \leq De / D max \leq 0.7 \qquad ( 14 )$$

where De is an effective diameter of the surface (e.g., lens surface) of the optical member on which at least one of the first and second phase shifters is formed, and Dmax is a maximum diameter of the area of that surface on which the phase shifter is formed. The effective diameter is the diameter of the effective area.

In a case where De/Dmax is lower than the lower limit of inequality (14), the external shape of the wafer-level optics will be large. In a case where De/Dmax becomes higher than the upper limit of inequality (14), the width of the outer circumferential area becomes too narrow relative to the effective area of the optical member, making it difficult to achieve a stable manufacturing process.

The lower limit of inequality (14) may be set to 0.12, 0.13, 0.14, or 0.15. The upper limit of inequality (14) may be set to 0.65, 0.60, 0.55, or 0.51.

The optical system according to each example will be described in detail below.

### Example 1

An optical system according to Example 1 illustrated in FIG. 1 includes, in this order from the object side to the image side, a first lens unit L1, a second lens unit L2, a third lens unit L3, and a cover glass 40.

The first lens unit L1 includes a substrate 11 serving as a parallel plate and a lens 12. The lens 12 is disposed closer to the object than the substrate 11.

The second lens unit L2 includes an aperture stop SP, a substrate 21 serving as a parallel plate, and a lens 22. The aperture stop SP is disposed on the object-side plane of the substrate 21, and the lens 22 is disposed closer to the image plane of the substrate 21. Furthermore, between the image-side plane of the substrate 21 and the object-side plane of the lens 22, a first transmissive reflective surface HM1 and a first phase shifter RT1 are arranged, in order from the object side. A second transmissive reflective surface HM2 is provided on the image-side curved surface of the lens 22.

The third lens unit L3 consists of a lens 32. A second phase shifter RT2 is provided on the object-side plane of the lens 32. The cover glass 40 is the cover glass of the image sensor IP and is a parallel plate.

The first lens unit L1 is formed by molding the lens 12 using curable resin on the substrate 11, which serves as a glass plate, using a mold.

In the second lens unit L2, an aperture stop SP is formed on the object-side plane of the substrate 11, which serves as a glass plate. A first transmissive reflective surface HM1 and a first phase shifter RT1 are provided on the image-side plane of the substrate 11, and the lens 22 is formed from curable resin on the first phase shifter RT1 using a mold.

The third lens unit L3 is formed by pouring and curing a curable resin between two lens-shaped molds arranged opposite each other, to form the object-side and image-side lens surface shapes of the lens 32. At this time, a planar, outer circumferential area outside the effective area of the lens 32 is also formed.

Each of the first to third lens units L1 to L3 is formed as a single wafer using a wafer process. The first to third lens units L1 to L3 and the cover glass 40 are then stacked using spacers and the like arranged outside their effective areas to form an optical system as wafer-level optics.

In Example 1, the first transmissive reflective surface HM1 is a polarization-selective transmissive reflective element, and the first phase shifter RT1 is a quarter-wave plate. The second transmissive reflective surface HM2 is a half-mirror, and the second phase shifter RT2 is a quarter-wave plate. Light incident from the object side transmits through the first transmissive reflective surface HM1, is reflected on the second transmissive reflective surface HM2, is reflected on the first transmissive reflective surface HM1, transmits through the second transmissive reflective surface HM2, and forms an image on the image plane IP.

A linear polarizer (not illustrated) may be disposed on the image side of the second phase shifter RT2 because it can cut out unnecessary polarized light. For example, forming a linear polarizer on the object-side plane of the lens 32 and then forming the second phase shifter RT2 on top of that can produce a good optical image with little flare.

In the optical system according to Example 1, the aperture stop SP is formed on the object-side surface of the second lens unit L2, but a light beam diaphragm separate from the aperture stop may also be provided. For example, forming a light beam diaphragm on the image-side plane of the first lens unit L1 can cut off flare of off-axis beams and effectively correct aberrations of off-axis beams. Such a light beam diaphragm may be provided in the optical systems according to Examples 2 to 8 described below, or a plurality of light beam diaphragms may be provided within an optical system. Furthermore, the location of the light beam diaphragm is not limited to the first lens unit L1; it may be disposed at a proper location for off-axis beams or for effective beams at on-axis or off-axis intermediate image heights.

### Example 2

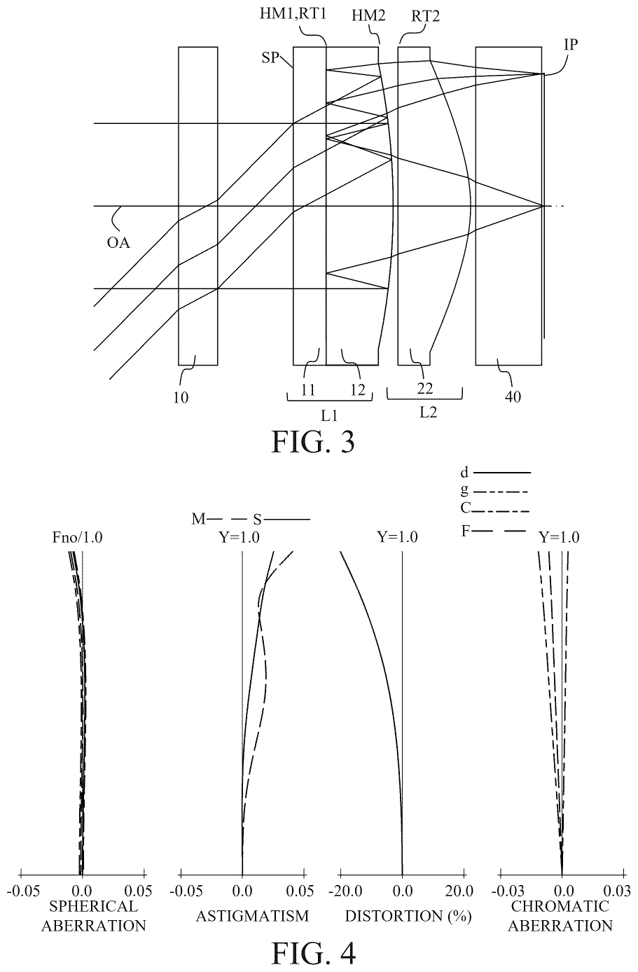

An optical system according to Example 2 illustrated in FIG. 3 includes, in order from the object side to the image side, a cover glass 10, a first lens unit L1, a second lens unit L2, and a cover glass 40.

The cover glass 10 is a plane-parallel plate disposed closest to the object in the optical system. The first lens unit L1 includes an aperture stop SP, a substrate 11 serving as a plane-parallel plate, and a lens 12. The aperture stop SP is provided on the object-side plane of the substrate 11, and the lens 12 is provided on the image side of the substrate 11. Between the image-side plane of the substrate 11 and the object-side plane of the lens 12, a first transmissive reflective surface HM1 and a first phase shifter RT1 are disposed, in that order from the object side. Furthermore, a second transmissive reflective surface HM2 is provided on the image-side lens surface of the lens 12.

The second lens unit L2 includes a lens 22. A second phase shifter RT2 is provided on the object-side plane of the lens 22. The cover glass 40 is the cover glass of the image sensor IP and is a plane-parallel plate.

In this example, as in Example 1, each lens unit is molded using a mold, and then the cover glass 10, first and second lens units L1 and L2, and cover glass 40 are stacked using spacers etc. disposed outside the effective area to form an optical system serving as wafer-level optics.

In this example, the first transmissive reflective surface HM1, first phase shifter RT1, second transmissive reflective surface HM2, and second phase shifter RT2 are the same polarizers as in Example 1, and the optical path for light from the object side is also similar to that in the optical system according to Example 1. Also in this example, as in Example 1, a linear polarizer may be disposed on the image side of the second phase shifter RT2.

### Example 3

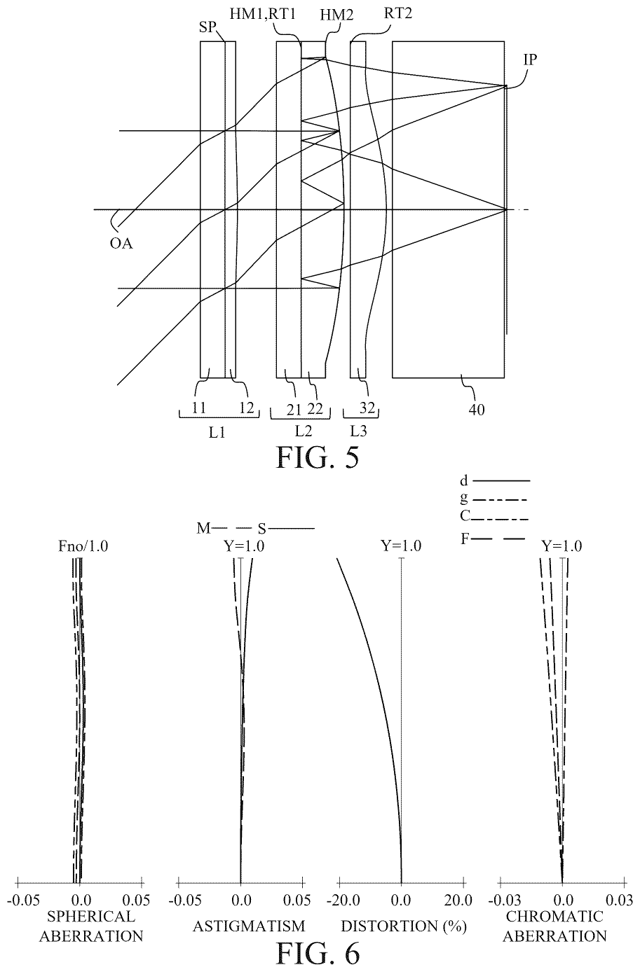

An optical system according to Example 3, illustrated in FIG. 5, includes, in order from object side to image side, a first lens unit L1, a second lens unit L2, a third lens unit L3, and a cover glass 40.

The first lens unit L1 includes a substrate 11 serving as a parallel plate and a lens 12. The lens 12 is disposed on the object side of substrate 11.

The second lens unit L2 includes an aperture stop SP, a substrate 21 serving as a parallel plate, and a lens 22. The aperture stop SP is provided on the object-side plane of substrate 21. The lens 22 is disposed on the image side of substrate 21. Furthermore, a first transmissive reflective surface HM1 and a first phase shifter RT1 are disposed, in order from the object side, between the image-side plane of substrate 21 and the object-side plane of lens 22. A second transmissive reflective surface HM2 is provided on the curved surface of the lens 22 on the image side.

The third lens unit L3 includes a lens 32. A second phase shifter RT2 is provided on the object-side plane of lens 32. The cover glass 40 is the cover glass of the image sensor IP and is a parallel plate.

In this example, as in Example 1, each lens unit is molded using a mold, and then the first to third lens units L1 to L3 and the cover glass 40 are stacked using spacers etc. disposed outside the effective area to form an optical system serving as wafer-level optics.

In this example, the first transmissive reflective surface HM1, the first phase shifter RT1, the second transmissive reflective surface HM2, and the second phase shifter RT2 are the same polarizers as those in Example 1, and the optical path for light from the object side is also similar to that in the optical system according to Example 1. In this example, as in Example 1, a linear polarizer may be disposed on the image side of the second phase shifter RT2.

### Example 4

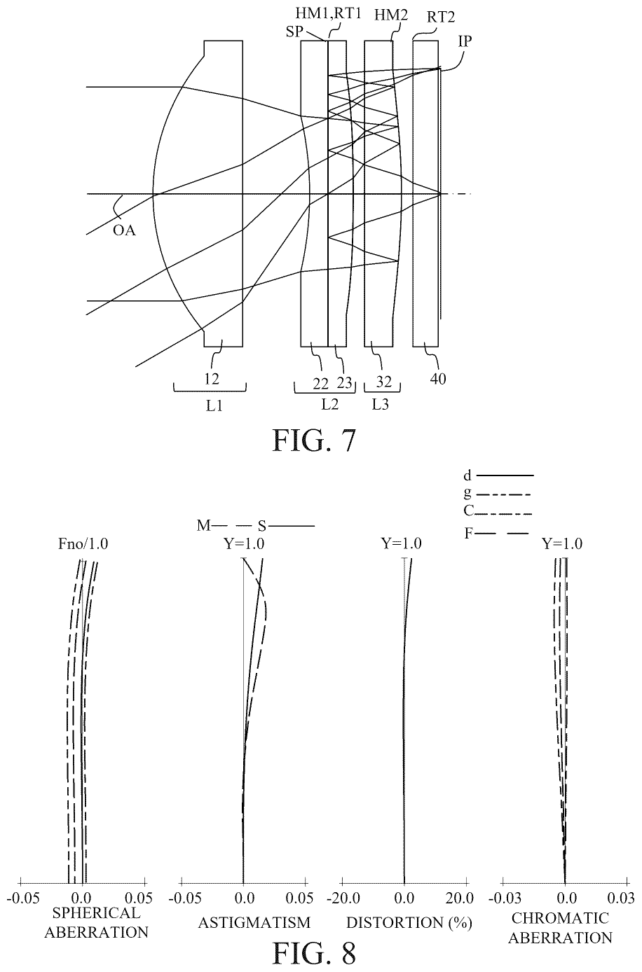

An optical system according to Example 4, illustrated in FIG. 7, includes, in order from object side to image side, a first lens unit L1, a second lens unit L2, a third lens unit L3, and a cover glass 40.

The first lens unit L1 includes a lens 12. The second lens unit L2 includes an aperture stop SP, a lens 22, and a lens 23. The aperture stop SP is disposed on the image-side plane of the lens 22. The lens 23 is cemented to the image-side plane of the lens 22. Furthermore, a first transmissive reflective surface HM1 and a first phase shifter RT1 are arranged, in order from the object side, between the image-side plane of lens 22 and the object-side plane of lens 23.

The third lens unit L3 includes a lens 32. The object-side surface of the lens 32 is flat. A second transmissive reflective surface HM2 is provided on the image-side curved surface of the lens 32. The cover glass 40 is the cover glass of an image sensor IP and is a parallel plate. A second phase shifter RT2 is provided on the object-side plane of the cover glass 40. In this example, as in Example 1, each lens unit is molded using a mold, and then the first to third lens units L1 to L3 and the cover glass 40 are stacked using spacers etc. disposed outside the effective area to form an optical system serving as wafer-level optics.

In this example, the first transmissive reflective surface HM1, the first phase shifter RT1, the second transmissive reflective surface HM2, and the second phase shifter RT2 are the same polarizers as those in Example 1, and the optical path for light from the object side is also similar to that of the optical system according to Example 1. In this example, as in Example 1, a linear polarizer may be disposed on the image side of the second phase shifter RT2.

### Example 5

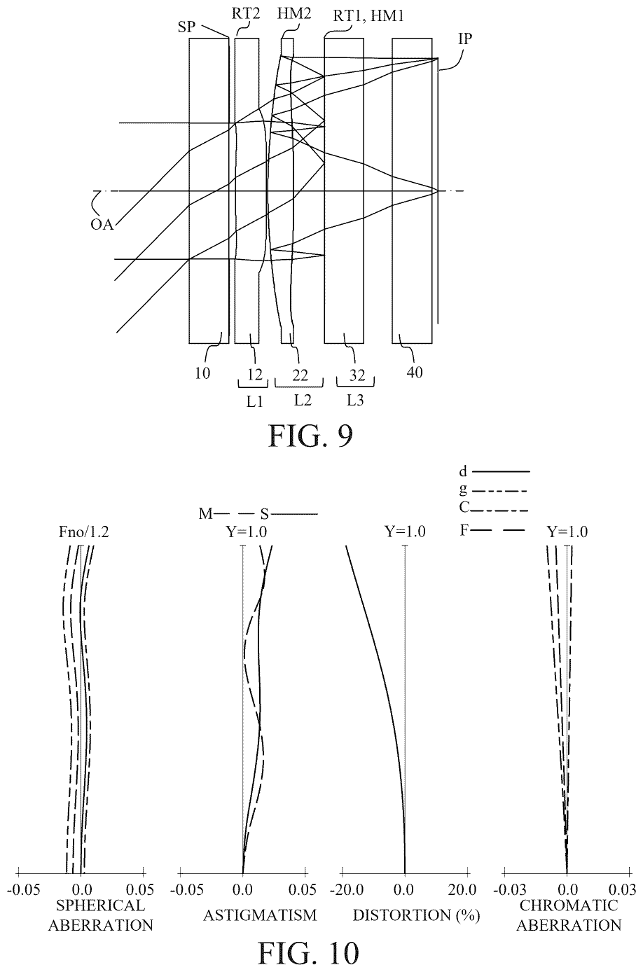

An optical system according to Example 5, illustrated in FIG. 9, includes, in order from the object side, a cover glass 10, a first lens unit L1, a second lens unit L2, a third lens unit L3, and a cover glass 40. In the optical systems according to Examples 1 to 4, the first and second phase shifters are arranged on a plane, but the optical systems according to Examples 5 and 7 have a different configuration.

The aperture stop SP is disposed on the image-side plane of the cover glass 10, which is a parallel plate. The first lens unit L1 includes a lens 12. The second phase shifter RT2 is disposed on the object-side curved surface (lens surface) of the lens 12.

The second lens unit L2 includes a lens 22. The second transmissive reflective surface HM2 is disposed on the object-side curved surface of the lens 22.

The third lens unit L3 includes a substrate 32, which is a parallel plate. The first phase shifter RT1 and the first transmissive reflective surface HM1 are arranged, in order from the object side, on the object-side plane of the substrate 32. The cover glass 40 is the cover glass of the image sensor IP and is a parallel plate.

In this example, as in Example 1, each lens unit is molded using a mold. In this case, by reducing the curvature of the object-side lens surface of lens 12, the second phase shifter RT2 can be stably formed over the entire surface of the wafer using a wafer process. The cover glass 10, first to third lens units L1 to L3, and cover glass 40 are then stacked using spacers etc. disposed outside the effective area to form an optical system as wafer-level optics.

In this example, the first transmissive reflective surface HM1, the first phase shifter RT1, the second transmissive reflective surface HM2, and the second phase shifter RT2 are the same polarizers as those in Example 1. Light incident from the object side transmits through the second transmissive reflective surface HM2, is reflected on the first transmissive reflective surface HM1, is reflected on the second transmissive reflective surface HM2, transmits through the first transmissive reflective surface HM1, and forms an image on the image plane IP.

In this example, a linear polarizer may be disposed on the object side of the second phase shifter RT2. For example, forming the second phase shifter RT2 on the object-side plane of the lens 12 and then laminating a linear polarizer on top of that can provide a good optical image with little flare.

### Example 6

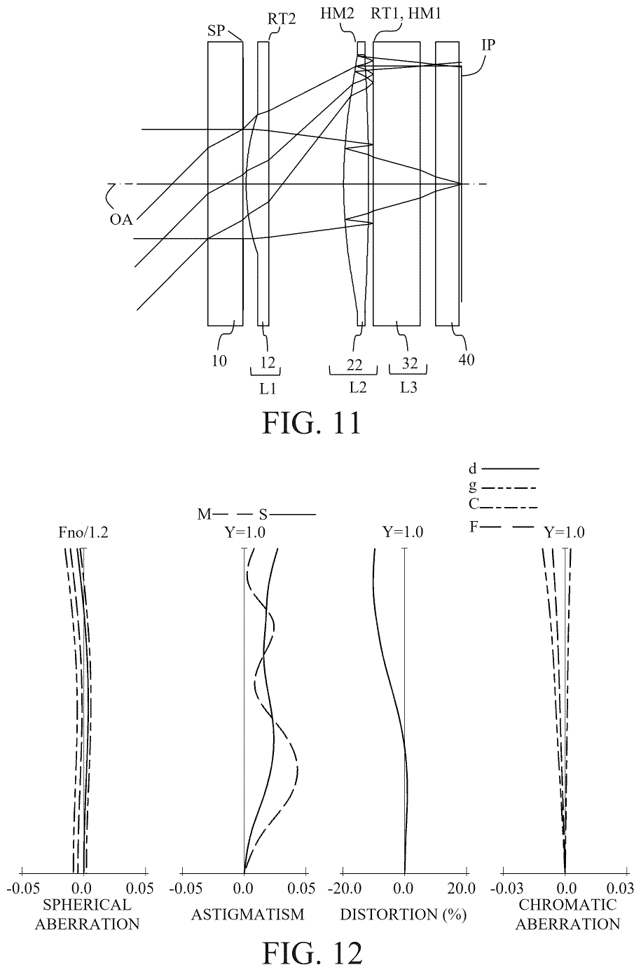

An optical system according to Example 6, illustrated in FIG. 11, includes, in order from the object side, a cover glass 10, a first lens unit L1, a second lens unit L2, a third lens unit L3, and a cover glass 40.

An aperture stop SP is provided on the image-side plane of the cover glass 10, which is a parallel plate. The first lens unit L1 includes a lens 12. The second phase shifter RT2 is provided on the image-side plane of the lens 12.

The second lens unit L2 includes a lens 22. A second transmissive reflective surface HM2 is provided on the object-side curved surface (lens surface) of the lens 22.

The third lens unit L3 includes a substrate 32, which is a parallel plate. On the object-side plane of substrate 32, a first phase shifter RT1 and a first transmissive reflective surface HM1 are provided, in order from the object side. A cover glass 40 is the cover glass of image sensor IP and is a parallel plate.

In this example, as in Example 1, each lens unit is molded using a mold, and then the cover glass 10, the first to third lens units L1 to L3, and the cover glass 40 are stacked using spacers etc. disposed outside the effective area to form an optical system as wafer-level optics.

In this example, the first transmissive reflective surface HM1, the first phase shifter RT1, the second transmissive reflective surface HM2, and the second phase shifter RT2 are the same polarizers as those in Example 1, and the optical path for light from the object side is similar to that in the optical system according to Example 5. This example may place a linear polarizer on the object side of second phase shifter RT2.

### Example 7

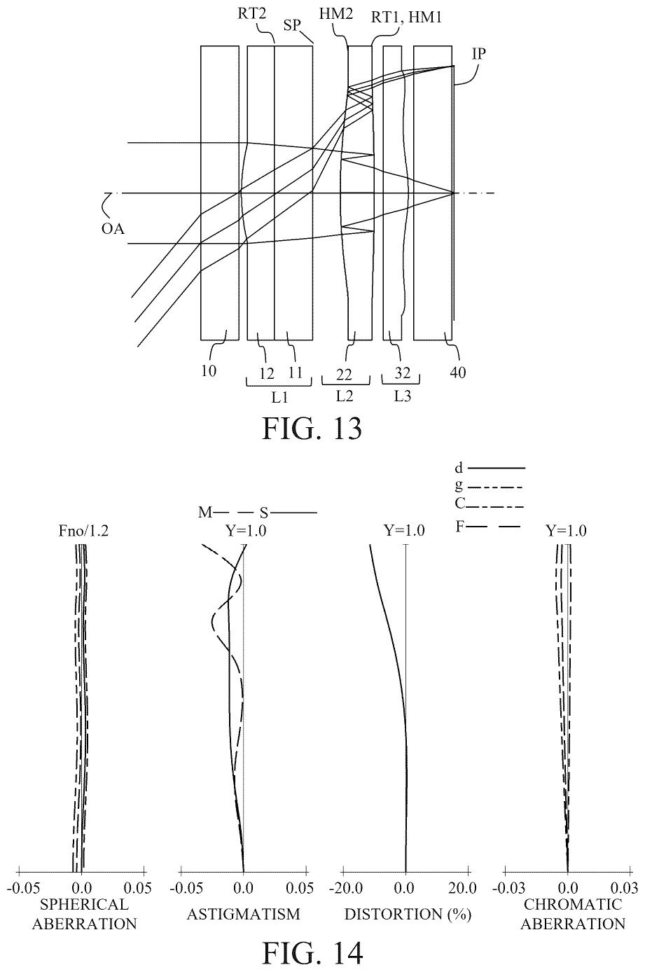

An optical system according to Example 7 illustrated in FIG. 13 includes, in order from the object side, a cover glass 10, a first lens unit L1, a second lens unit L2, a third lens unit L3, and a cover glass 40.

The first lens unit L1 includes a parallel plate substrate 11, a lens 12, and an aperture stop SP. The lens 12 is provided on the object side of the substrate 11, and the aperture stop SP is provided on the image-side plane of the substrate 11. Furthermore, a second phase shifter RT2 is provided on the object-side plane of the substrate 11.

The second lens unit L2 includes a lens 22. A second transmissive reflective surface HM2 is provided on the object-side curved surface (lens surface) of the lens 22. Furthermore, a first phase shifter RT1 and a first transmissive reflective surface HM1 are provided, in order from the object side, on the image-side curved surface of the lens 22.

The third lens unit L3 includes a lens 32. The cover glass 40 is the cover glass for the image sensor IP and is a parallel plate.

In this example, as in Example 1, each lens unit is molded using a mold. In this case, by reducing the curvature of the image-side lens surface of the lens 22, the first phase shifter RT1 can be stably formed over the entire surface of the wafer using a wafer process. The cover glass 10, the first to third lens units L1 to L3, and the cover glass 40 are then stacked using spacers etc. disposed outside the effective area to form an optical system as wafer-level optics. In this example, the first transmissive reflective surface HM1, the first phase shifter RT1, the second transmissive reflective surface HM2, and the second phase shifter RT2 are the same polarizers as in Example 1, and the optical path for light from the object side is similar to that of the optical system according to Example 5. Also in this example, a linear polarizer may be disposed on the object side of the second phase shifter RT2.

### Example 8

An optical system according to Example 8, illustrated in FIG. 15, includes, in order from the object side, a cover glass 10, a first lens unit L1, a second lens unit L2, and a cover glass 40.

The first lens unit L1 includes a parallel plate-like substrate 11, a lens 12, and an aperture stop SP. The lens 12 is disposed on the object side of the substrate 11, and the aperture stop SP is disposed on the image-side plane of the substrate 11. Furthermore, the second phase shifter RT2 is disposed on the object-side plane of the substrate 11.

The second lens unit L2 includes a lens 22, a substrate 21 which is a parallel plate, and a lens 23. The lens 22 is provided on the object side of the substrate 21, and the lens 23 is provided on the image side. A second transmissive reflective surface HM2 is provided on the object-side curved surface (lens surface) of the lens 22. Furthermore, a first phase shifter RT1 and a first transmissive reflective surface HM1 are provided, in order from the object side, on the image-side flat surface of the lens 22.

The cover glass 40 is the cover glass for the image sensor IP and is a parallel plate.

In this example, as in Example 1, each lens unit is molded using a mold, and then the cover glass 10, the first and second lens units L1 and L2, and the cover glass 40 are stacked using spacers etc. disposed outside the effective area to form an optical system as wafer-level optics.

In this example, the first transmissive reflective surface HM1, the first phase shifter RT1, the second transmissive reflective surface HM2, and the second phase shifter RT2 are the same polarizers as those in Example 1, and the optical path for light from the object side is similar to that in the optical system according to Example 5. This example may place a linear polarizer on the object side of the second phase shifter RT2.

Numerical Examples 1 to 8 corresponding to Examples 1 to 8, respectively, will be illustrated. In each numerical example, a surface number i indicates the order of a surface counted from the object side. r represents a radius of curvature (mm) of an i-th surface, d represents a lens thickness or air gap (mm) on the optical axis between i-th and (i+1)-th surfaces, and nd represents a refractive index for the d-line of the optical material between i-th and (i+1)-th surfaces. νd represents an Abbe number based on the d-line of an optical material between i-th and (i+1)-th surfaces.

The Abbe number νd based on the d-line is expressed as:

$$v d = ( N d - 1 ) / ( NF - NC )$$

where Nd, NF, and NC are refractive indices d-line (587.6 nm), F-line (486.1 nm), and C-line (656.3 nm) in the Fraunhofer line.

A focal length f (mm) is a value in an in-focus state on an object at infinity. BF is the back focus, which is the air-equivalent distance on the optical axis from the final surface closest to the image plane in the optical system to the image plane. The overall lens length is a distance on the optical axis from the first surface closest to the object of the optical system to the final surface plus the back focus, and is also known as the overall optical length.

An asterisk “*” next to a surface number indicates that the surface is aspherical. The aspheric shape is expressed by the following equation:

$$x ( h ) = \frac{( \frac{{h}^{2}}{R} )}{1 + \sqrt{\{ 1 - ( 1 + K ) {( \frac{h}{R} )}^{2} \}}} + {A}_{4} {h}^{4} + + {A}_{6} {h}^{6} + {A}_{8} {h}^{8} + {A}_{I 0} {h}^{I 0} + …$$

where x is a displacement amount in the optical axis direction at a height h from the optical axis relative to a surface vertex, R is a paraxial radius of curvature, K is a conic constant, and Ai (i=2, 4, 6, 8, . . . ) are the aspheric coefficients of each order.

“e±M” in the conic constant and aspheric coefficients means ×10^{±M}. The radius of curvature for each aspheric surface condition is calculated using the value of R.

In each numerical example, (IP) refers to the aperture stop. The effective diameter refers to the diameter of the effective area of each surface through which light contributing to imaging passes.

### Numerical Example 1

UNIT: mm
SURFACE DATA

| | | | | | Effective |
|---|---|---|---|---|---|
| Surface No. | r | d | nd | vd | Diameter |
| 1* | 1.6332 | 0.370 | 1.51100 | 57.0 | 1.82 |
| 2 | ∞ | 0.250 | 1.51680 | 64.2 | 1.71 |
| 3 | ∞ | 0.331 | | | 1.47 |
| 4 (SP) | ∞ | 0.248 | 1.51680 | 64.2 | 0.94 |
| 5 | ∞ | 0.292 | 1.51100 | 57.0 | 1.55 |
| 6* | −4.3312 | −0.292 | 1.51100 | 57.0 | 1.64 |
| 7 | ∞ | 0.292 | 1.51100 | 57.0 | 1.55 |
| 8* | −4.3312 | 0.042 | | | 1.64 |
| 9 | ∞ | 0.186 | 1.59000 | 31.0 | 1.69 |
| 10* | −3.7238 | 0.094 | | | 1.75 |
| 11 | ∞ | 0.236 | 1.51680 | 64.2 | 1.83 |
| 12 | ∞ | 0.020 | | | 1.99 |
| Image Plane | ∞ | | | | |

ASPHERIC DATA
1st Surface
K = 0.00000e+00, A4 = −3.20510e-02, A6 = −1.58626e-02
6th Surface
K = 0.00000e+00, A4 = 1.12785e-02, A6 = 7.76210e-03
8th Surface
K = 0.00000e+00, A4 = 1.12785e-02, A6 = 7.76210e-03
10th Surface
K = 0.00000e+00, A4 = 3.11132e-01, A6 = −2.76747e-01,
A8 = 1.94275e-01

| | |
|---|---|
| Focal Length | 1.177 |
| Fno | 1.000 |
| Half Angle of View (°) | 40.002 |
| Image Height | 1.000 |
| Overall Lens Length | 2.069 |
| BF | 0.020 |

### Numerical Example 2

UNIT: mm
SURFACE DATA

| | | | | | Effective |
|---|---|---|---|---|---|
| Surface No. | r | d | nd | vd | Diameter |
| 1 | ∞ | 0.297 | 1.51680 | 64.2 | 1.56 |
| 2 | ∞ | 0.576 | | | 1.25 |
| 3 (SP) | ∞ | 0.249 | 1.51680 | 64.2 | 1.25 |
| 4 | ∞ | 0.511 | 1.51100 | 57.0 | 2.05 |
| 5* | −4.9094 | −0.511 | 1.51100 | 57.0 | 2.15 |
| 6 | ∞ | 0.511 | 1.51100 | 57.0 | 2.05 |
| 7* | −4.9094 | 0.036 | | | 2.15 |
| 8 | ∞ | 0.551 | 1.51100 | 57.0 | 2.17 |
| 9* | −1.2657 | 0.040 | | | 2.19 |
| 10 | ∞ | 0.501 | 1.51680 | 64.2 | 2.09 |
| 11 | ∞ | 0.019 | | | 2.01 |
| Image Plane | ∞ | | | | |

ASPHERIC DATA
5th Surface
K = 0.00000e+00, A4 = 8.25908e-03, A6 = −2.81294e-03
7th Surface
K = 0.00000e+00, A4 = 8.25908e-03, A6 = −2.81294e-03
9th Surface
K = 0.00000e+00, A4 = 3.45758e-01, A6 = −2.37483e-01,
A8 = 1.14847e-01

| | |
|---|---|
| Focal Length | 1.246 |
| Fno | 1.000 |
| Half Angle of View (°) | 45.096 |
| Image Height | 1.000 |
| Overall Lens Length | 2.780 |
| BF | 0.019 |

### Numerical Example 3

UNIT: mm
SURFACE DATA

| | | | | | Effective |
|---|---|---|---|---|---|
| Surface No. | r | d | nd | vd | Diameter |
| 1 | ∞ | 0.200 | 1.51680 | 64.2 | 1.48 |
| 2 (SP) | ∞ | 0.100 | 1.51100 | 57.0 | 1.27 |
| 3* | −9.1871 | 0.316 | | | 1.36 |
| 4 | ∞ | 0.199 | 1.51680 | 64.2 | 2.02 |
| 5 | ∞ | 0.347 | 1.51100 | 57.0 | 2.43 |
| 6* | −5.3501 | −0.347 | 1.51100 | 57.0 | 2.45 |
| 7 | ∞ | 0.347 | 1.51100 | 57.0 | 2.43 |
| 8* | −5.3501 | 0.050 | | | 2.45 |
| 9 | ∞ | 0.292 | 1.51100 | 57.0 | 2.32 |
| 10* | −2.1405 | 0.049 | | | 2.28 |
| 11 | ∞ | 0.905 | 1.51680 | 64.2 | 2.20 |
| 12 | ∞ | 0.020 | | | 2.01 |
| Image Plane | ∞ | | | | |

ASPHERIC DATA
3rd Surface
K = 0.00000e+00, A4 = 4.91305e-02, A6 = −2.94331e-02,
A8 = 8.41495e-02
6th Surface
K = 0.00000e+00, A4 = 4.05400e-03, A6 = −5.21411e-03,
A8 = 3.90705e-04
8th Surface
K = 0.00000e+00, A4 = 4.05400e-03, A6 = −5.21411e-03,
A8 = 3.90705e-04
10th Surface
K = 0.00000e+00 , A4 = 7.86580e-02, A6 = −1.36331e-02,
A8 = 2.07391e-02

| | |
|---|---|
| Focal Length | 1.265 |
| Fno | 1.000 |
| Half Angle of View (°) | 44.994 |
| Image Height | 1.000 |
| Overall Lens Length | 2.477 |
| BF | 0.020 |

### Numerical Example 4

UNIT: mm
SURFACE DATA

| | | | | | Effective |
|---|---|---|---|---|---|
| Surface No. | r | d | nd | vd | Diameter |
| 2 | ∞ | 0.528 | | | 1.69 |
| 3 | −2.6785 | 0.144 | 1.59000 | 31.0 | 1.22 |
| 4 (SP) | ∞ | 0.200 | 1.51100 | 57.0 | 1.18 |
| 5* | −14.4948 | 0.089 | | | 1.89 |
| 6 | ∞ | 0.291 | 1.63000 | 24.0 | 1.92 |
| 7* | −5.3414 | −0.291 | 1.63000 | 24.0 | 1.94 |
| 8 | ∞ | −0.089 | | | 1.92 |
| 9* | −14.4948 | −0.200 | 1.51100 | 57.0 | 1.89 |
| 10 | ∞ | 0.200 | 1.51100 | 57.0 | 1.85 |
| 11* | −14.4948 | 0.089 | | | 1.89 |
| 12 | ∞ | 0.291 | 1.63000 | 24.0 | 1.92 |
| 13* | −5.3414 | 0.090 | | | 1.94 |
| 14 | ∞ | 0.200 | 1.51680 | 64.2 | 1.96 |
| 15 | ∞ | 0.020 | | | 1.98 |
| Image Plane | ∞ | | | | |

ASPHERIC DATA
1 st Surface
K = 0.00000e+00, A4 = −1.60722e-03, A6 = −4.91427e-03
5th Surface
K = 0.00000e+00, A4 = −3.57407e-02, A6 = 7.24758e-03
7th Surface
K = 0.00000e+00, A4 = 2.21179e-02, A6 = 1.76019e-03
9th Surface
K = 0.00000e+00, A4 = −3.57407e-02, A6 = 7.24758e-03
11th Surface
K = 0.00000e+00, A4 = −3.57407e-02, A6 = 7.24758e-03
13th Surface
K = 0.00000e+00, A4 = 2.21179e-02, A6 = 1.76019e-03

| | |
|---|---|
| Focal Length | 1.677 |
| Fno | 1.000 |
| Half Angle of View (°) | 29.750 |
| Image Height | 1.000 |
| Overall Lens Length | 2.271 |
| BF | 0.020 |

### Numerical Example 5

UNIT: mm
SURFACE DATA

| | | | | | Effective |
|---|---|---|---|---|---|
| Surface No. | r | d | nd | vd | Diameter |
| 2 | ∞ | 0.005 | | | 1.03 |
| 3 (SP) | ∞ | 0.044 | | | 1.03 |
| 4* | 6.0000 | 0.236 | 1.52290 | 50.3 | 1.03 |
| 5* | 610.6653 | 0.010 | | | 1.24 |
| 6* | 4.5224 | 0.196 | 1.52290 | 50.3 | 2.03 |
| 7* | −24.2620 | 0.236 | | | 2.01 |
| 8 | ∞ | −0.236 | | | 2.01 |
| 9* | −24.2620 | −0.196 | 1.52290 | 50.3 | 2.01 |
| 10* | 4.5224 | 0.196 | 1.52290 | 50.3 | 2.03 |
| 11* | −24.2620 | 0.236 | | | 2.01 |
| 12 | ∞ | 0.296 | 1.51680 | 64.2 | 2.01 |
| 13 | ∞ | 0.217 | | | 2.00 |
| 14 | ∞ | 0.300 | 1.51680 | 64.2 | 2.00 |
| 15 | ∞ | 0.046 | | | 2.00 |
| Image Plane | ∞ | | | | |

ASPHERIC DATA
4th Surface
K = 0.00000e+00, A4 = −1.40474e-01, A6 = −7.17880e-01,
A8 = 8.21507e-01, A10 = −3.55134e+00
5th Surface
K = 0.00000e+00, A4 = 2.92872e-03, A6 = −1.57608e+00,
A8 = 2.80237e+00, A10 = −3.82436e+00
6th Surface
K = 0.00000e+00, A4 = −9.11629e-02, A6 = 1.96323e-01,
A8 = −2.01147e-01, A10 = 7.36729e-02, A12 = 5.63879e-03
7th Surface
K = 0.00000e+00, A4 = −2.19409e-01, A6 = 6.24596e-01,
A8 = −6.92580e-01, A10 = 3.02219e-01
9th Surface
K = 0.00000e+00, A4 = −2.19409e-01, A6 = 6.24596e-01,
A8 = −6.92580e-01, A10 = 3.02219e-01
10th Surface
K = 0.00000e+00, A4 = −9.11629e-02, A6 = 1.96323e-01,
A8 = −2.01147e-01, A10 = 7.36729e-02, A12 = 5.63879e-03
11th Surface
K = 0.00000e+00, A4 = −2.19409e-01, A6 = 6.24596e-01,
A8 = −6.92580e-01, A10 = 3.02074e-01

| | |
|---|---|
| Focal Length | 1.234 |
| Fno | 1.200 |
| Half Angle of View (°) | 45.015 |
| Image Height | 1.000 |
| Overall Lens Length | 1.885 |
| BF | 0.046 |

### Numerical Example 6

UNIT: mm
SURFACE DATA

| | | | | | Effective |
|---|---|---|---|---|---|
| Surface No. | r | d | nd | vd | Diameter |
| 2 | ∞ | 0.005 | | | 0.93 |
| 3 (SP) | ∞ | 0.024 | | | 0.93 |
| 4* | 1.8702 | 0.191 | 1.51100 | 57.0 | 1.17 |
| 5 | ∞ | 0.638 | | | 1.23 |
| 6* | 3.7680 | 0.212 | 1.51100 | 57.0 | 2.17 |
| 7* | 555.4841 | 0.038 | | | 2.17 |
| 8 | ∞ | −0.038 | | | 2.13 |
| 9* | 555.4841 | −0.212 | 1.51100 | 57.0 | 2.13 |
| 10* | 3.7680 | 0.212 | 1.51100 | 57.0 | 2.17 |
| 11* | 555.4841 | 0.038 | | | 2.17 |
| 12 | ∞ | 0.402 | 1.51680 | 64.2 | 2.13 |
| 13 | ∞ | 0.130 | | | 2.13 |
| 14 | ∞ | 0.200 | 1.51680 | 64.2 | 2.03 |
| 15 | ∞ | 0.020 | | | 2.05 |
| Image Plane | ∞ | | | | |

ASPHERIC DATA
4th Surface
K = 0.00000e+00, A4 = −3.72792e-02, A6 = 3.75079e-01,
A8 = −1.10736e+00, A10 = 1.19517e+00
6th Surface
K = 0.00000e+00, A4 = −1.54225e-01, A6 = 3.65682e-01,
A8 = −3.64765e-01, A10 = 1.14835e-01, A12 = 5.63879e-03
7th Surface
K = 0.00000e+00, A4 = −2.65705e-01, A6 = 7.48177e-01,
A8 = −8.18422e-01, A10 = 3.05930e-01
9th Surface
K = 0.00000e+00, A4 = −2.65705e-01, A6 = 7.48177e-01,
A8 = −8.18422e-01, A10 = 3.05930e-01
10th Surface
K = 0.00000e+00, A4 = −1.54225e-01, A6 = 3.65682e-01,
A8 = −3.64765e-01, A10 = 1.14835e-01, A12 = 5.63879e-03
11th Surface
K = 0.00000e+00, A4 = −2.65705e-01, A6 = 7.48177e-01,
A8 = −8.18422e-01, A10 = 3.05785e-01

| | |
|---|---|
| Focal Length | 1.106 |
| Fno | 1.200 |
| Half Angle of View (°) | 44.988 |
| Image Height | 1.000 |
| Overall Lens Length | 2.160 |
| BF | 0.020 |

### Numerical Example 7

UNIT: mm
SURFACE DATA

| | | | | | Effective |
|---|---|---|---|---|---|
| Surface No. | r | d | nd | vd | Diameter |
| 2 | ∞ | 0.019 | | | 0.86 |
| 3* | 1.5023 | 0.262 | 1.51100 | 57.0 | 0.79 |
| 4 | ∞ | 0.300 | 1.51633 | 64.1 | 0.75 |
| 5 (SP) | ∞ | 0.217 | | | 0.70 |
| 6* | 4.7958 | 0.268 | 1.51100 | 57.0 | 1.66 |
| 7 | −19.9999 | −0.268 | 1.51100 | 57.0 | 1.76 |
| 8* | 4.7958 | 0.268 | 1.51100 | 57.0 | 1.66 |
| 9 | −19.9999 | 0.069 | | | 1.76 |
| 10 | ∞ | 0.199 | 1.51100 | 57.0 | 1.84 |
| 11* | −1.2339 | 0.043 | | | 1.91 |
| 12 | ∞ | 0.300 | 1.51630 | 64.1 | 1.94 |
| 13 | ∞ | 0.020 | | | 1.99 |
| Image Plane | ∞ | | | | |

ASPHERIC DATA
3rd Surface
K = 0.00000e+00, A4 = −2.81684e-01, A6 = 2.78610e+00,
A8 = −1.90813e+01, A10 = 4.59089e+01
6th Surface
K = 0.00000e+00, A4 = 3.86423e-02, A6 = −2.20030e-01,
A8 = 3.65002e-01, A10 = −2.55735e-01
8th Surface
K = 0.00000e+00, A4 = 3.86423e-02, A6 = −2.20030e-01,
A8 = 3.65002e-01, A10 = −2.55735e-01
11th Surface
K = 0.00000e+00, A4 = 1.51067e+00, A6 = −2.40038e+00,
A8 = 2.26514e+00, A10 = −9.50613e-01

| | |
|---|---|
| Focal Length | 0.945 |
| Fno | 1.200 |
| Half Angle of View (°) | 49.944 |
| Image Height | 1.000 |
| Overall Lens Length | 1.996 |
| BF | 0.020 |

### Numerical Example 8

UNIT: mm
SURFACE DATA

| | | | | | Effective |
|---|---|---|---|---|---|
| Surface No. | r | d | nd | vd | Diameter |
| 2 | ∞ | 0.019 | | | 0.68 |
| 3* | 2.1966 | 0.136 | 1.51100 | 57.0 | 0.68 |
| 4 | ∞ | 0.300 | 1.51633 | 64.1 | 0.67 |
| 5 (SP) | ∞ | 0.235 | | | 0.64 |
| 6* | 3.7739 | 0.303 | 1.51100 | 57.0 | 1.89 |
| 7 | ∞ | −0.303 | 1.51100 | 57.0 | 1.94 |
| 8* | 3.7739 | 0.303 | 1.51100 | 57.0 | 1.89 |
| 9 | ∞ | 0.194 | 1.51633 | 64.1 | 1.94 |
| 10 | ∞ | 0.248 | 1.51100 | 57.0 | 2.00 |
| 11* | −1.3052 | 0.043 | | | 2.04 |
| 12 | ∞ | 0.300 | 1.51630 | 64.1 | 2.02 |
| 13 | ∞ | 0.020 | | | 2.00 |
| Image Plane | ∞ | | | | |

ASPHERIC DATA
3rd Surface
K = 0.00000e+00, A4 = −3.33088e-01, A6 = 5.38088e+00,
A8 = −4.97978e+01, A10 = 1.64527e+02
6th Surface
K = 0.00000e+00, A4 = 1.51298e-02, A6 = −8.51722e-02,
A8 = 1.12788e-01, A10 = −6.23417e-02
8th Surface
K = 0.00000e+00, A4 = 1.51298e-02, A6 = −8.51722e-02,
A8 = 1.12788e-01, A10 = −6.23417e-02
11th Surface
K = 0.00000e+00, A4 = 1.02526e+00, A6 = −1.29804e+00,
A8 = 1.01519e+00, A10 = −3.69473e-01

| | |
|---|---|
| Focal Length | 0.953 |
| Fno | 1.400 |
| Half Angle of View (*) | 54.963 |
| Image Height | 1.000 |
| Overall Lens Length | 2.097 |
| BF | 0.020 |

Table 1 summarizes the values of inequalities (1) to (14) in each numerical example. In Table 1, De1, which corresponds to De in inequality (14), indicates the effective diameter of the first phase shifter, and De2 indicates the effective diameter of the second phase shifter. The optical system according to each numerical example satisfies all of inequalities (1) to (14).

TABLE 1

| | Numerical Example | | | | | | | |
|---|---|---|---|---|---|---|---|---|
| Inequality | 1 | 2 | 3 | 4 | 5 | 6 | 7 | 8 |
| f | 1.177 | 1.246 | 1.265 | 1.677 | 1.234 | 1.106 | 0.945 | 0.953 |
| Inequality (11) Fno | 1.0 | 1.0 | 1.0 | 1.0 | 1.2 | 1.2 | 1.2 | 1.4 |
| Y | 1.00 | 1.00 | 1.00 | 1.00 | 1.00 | 1.00 | 1.00 | 1.00 |
| Inequality (1) Y/Rh1 | 0.00 | 0.00 | 0.00 | 0.00 | 0.00 | 0.00 | 0.05 | 0.00 |
| Inequality (2) Y/Rr1 | 0.00 | 0.00 | 0.00 | 0.00 | 0.00 | 0.00 | 0.05 | 0.00 |
| Inequality (3) Y/Rr2 | 0.00 | 0.00 | 0.00 | 0.00 | 0.17 | 0.00 | 0.00 | 0.00 |
| Lsp | 0.540 | 0.686 | 0.919 | 0.392 | 0.838 | 0.857 | 0.840 | 0.640 |
| L | 2.069 | 2.780 | 2.477 | 2.271 | 1.885 | 2.140 | 1.996 | 2.097 |
| Inequality (4) (FNo×Y)/f | 0.849 | 0.802 | 0.790 | 0.596 | 0.973 | 1.085 | 1.269 | 1.469 |
| Inequality (5) Lsp/L | 0.540 | 0.686 | 0.919 | 0.392 | 0.838 | 0.857 | 0.840 | 0.640 |
| Inequality (6) 0m | 0.000 | 0.000 | 0.000 | 0.000 | 9.741 | 0.000 | 0.000 | 0.000 |
| Inequality (7) Nc | 3 | 2 | 3 | 4 | 4 | 3 | 4 | 3 |
| Ls1 | 0.540 | 0.760 | 0.962 | 0.580 | 0.721 | 1.103 | 1.047 | 0.538 |
| Inequality (8) Ls1/L | 0.261 | 0.273 | 0.388 | 0.255 | 0.382 | 0.516 | 0.524 | 0.256 |
| Rhm | −4.331 | −4.909 | −5.350 | −5.341 | 4.522 | 3.768 | 4.796 | 3.774 |
| Inequality (9) \|Rhm/f\| | 3.679 | 3.940 | 4.229 | 3.185 | 3.666 | 3.408 | 5.073 | 3.960 |
| Lf | 0.535 | 1.111 | 1.266 | 0.220 | 0.859 | 0.731 | 0.630 | 0.805 |
| Inequality (10) Lf/(f×FNo) | 0.455 | 0.892 | 1.000 | 0.131 | 0.580 | 0.551 | 0.556 | 0.603 |
| Lhm | 0.292 | 0.511 | 0.347 | 0.580 | 0.432 | 0.250 | 0.268 | 0.303 |
| Inequality (12) Lhm/L | 0.141 | 0.184 | 0.140 | 0.255 | 0.229 | 0.117 | 0.134 | 0.144 |
| Inequality (13) NL | 1.511~1.590 | 1.511 | 1.511 | 1.511~1.630 | 1.523 | 1.511 | 1.511 | 1.511 |
| Dmax | 4.808 | 4.808 | 4.808 | 4.808 | 4.808 | 4.808 | 4.808 | 4.808 |
| Inequality(14) Del/Dmax | 0.321 | 0.427 | 0.505 | 0.246 | 0.417 | 0.443 | 0.367 | 0.404 |
| De2/Dmax | 0.351 | 0.451 | 0.482 | 0.407 | 0.214 | 0.255 | 0.157 | 0.139 |

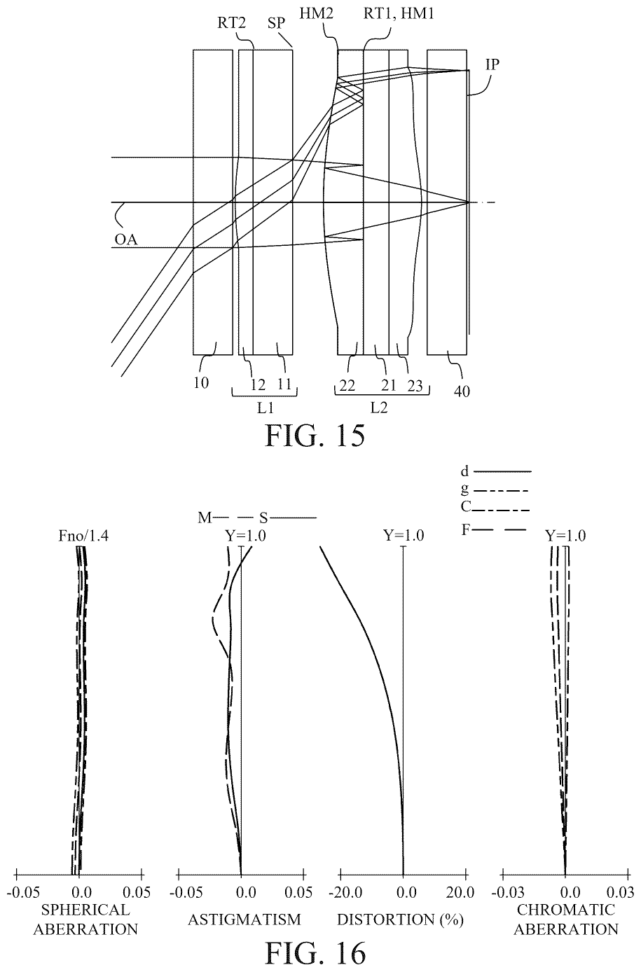

FIGS. 2, 4, 6, 8, 10, 12, 14, and 16 illustrate longitudinal aberrations (spherical aberration, astigmatism, distortion, and chromatic aberration) of the optical systems of numerical examples 1 to 8 in an in-focus state on an object at infinity. In the spherical aberration diagram, Fno represents an F-number. A solid line represents a spherical aberration amount for the d-line (wavelength 587.6 nm), an alternate long and two short dashes line represents a spherical aberration amount for the g-line (wavelength 435.8 nm), an alternate long and short dash line represents a spherical aberration amount for the C-line (wavelength 656.3 nm), and a long broken line represents a spherical aberration amount for the F-line (wavelength 486.1 nm). In the astigmatism diagram, a solid line S represents an astigmatism amount on a sagittal image plane for the d-line as the designed wavelength, and a broken line M represents an astigmatism amount on a meridional image plane at the designed wavelength. The distortion diagram illustrates a distortion amount for light with a designed wavelength. The chromatic aberration diagram illustrates a lateral chromatic aberration amount for the g-line, C-line, and F-line. Y represents an image height.

As described above, each example (numerical example) can effectively correct a variety of aberrations in the visible wavelength range, and achieve an optical system with a reduced size, overall optical length, and maximum diameter.

### Image Pickup Apparatus 1

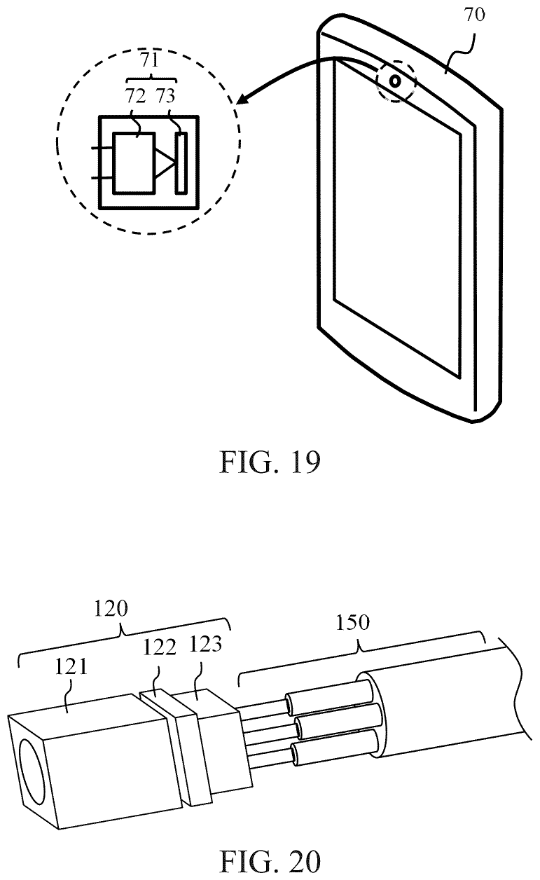

FIG. 19 illustrates a smartphone 70 as an electronic apparatus incorporating an image pickup apparatus using the optical system according to any one of Examples 1 to 8. The smartphone 70 includes an image pickup apparatus 71 as a front camera module. The image pickup apparatus 71 includes an imaging optical system 72 that is one of the optical systems according to Examples 1 to 8, and an image sensor 73 that photoelectrically converts an optical image formed by the imaging optical system 72 (capturing the object).

Thus, using the optical system according to each example in an image pickup apparatus incorporated into an electronic apparatus such as a smartphone can achieve a compact electronic apparatus capable of capturing high-quality images.

### Image Pickup Apparatus 2

FIG. 20 illustrates an endoscope 100 as an image pickup apparatus using the optical system according to any one of Examples 1 to 8. The endoscope 100 includes a camera head 120 and an electrical cable 150. The camera head 120 includes a lens housing 121 having an imaging optical system that is one of the optical systems according to Examples 1 to 8, an image sensor 122, and a ceramic substrate 123. The electrical cable 150 is connected to the image sensor 122 via the ceramic substrate 123.

Using the optical system of each example for an image pickup apparatus such as an endoscope can achieve an image pickup apparatus that has a simple configuration and a reduced size, can sufficiently suppress a variety of aberrations, and can be easily manufactured.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example can provide a good optical system that uses a polarizer.

This application claims the benefit of Japanese Patent Application No. 2025-025589, filed on Feb. 20, 2025, and which is hereby incorporated by reference herein in its entirety.

What is claimed is:

1. An optical system comprising, in order:
a first transmissive reflective surface;
a first phase shifter;
a second transmissive reflective surface; and
a second phase shifter,
wherein the following inequalities are satisfied:
$$\vert Y / Rh 1 \vert \leq 0.2$$
$$\vert Y / Rr 1 \vert \leq 0.2$$
$$\vert Y / Rr 2 \vert \leq 0.2$$
where Rh1 is a radius of curvature on an optical axis of the first transmissive reflective surface, Rr1 is a radius of curvature on the optical axis of a surface on which the first phase shifter is provided, and Rr2 is a radius of curvature on the optical axis of a surface on which the second phase shifter is provided.

2. The optical system according to claim 1, wherein the following inequality is satisfied:
$$0.3 \leq ( FNo \times Y ) / f \leq 1.75$$
where f is a focal length of the optical system, FNo is an F-number, and Y is a maximum image height.

3. The optical system according to claim 1, wherein the following inequality is satisfied:
$$0.2 \leq Lsp / L \leq 1.5$$
where Lsp is a distance on the optical axis from an aperture stop to an image plane, and L is a distance on the optical axis from an optical surface closest to an object in the optical system to the image plane.

4. The optical system according to claim 1, wherein the second phase shifter is provided on a lens surface in a lens that does not include the first transmissive reflective surface or the second transmissive reflective surface, and
wherein the following inequality is satisfied:
$$0 \leq θ m \leq 15$$
where θm (deg) is a maximum angle between a normal to the lens surface and the optical axis.

5. The optical system according to claim 1, wherein the following inequality is satisfied:
$$2 \leq Nc \leq 7$$
where Nc is the number of lens surfaces with power in the optical system.

6. The optical system according to claim 1, wherein the first transmissive reflective surface and the first phase shifter are stacked on top of each other.

7. The optical system according to claim 1, further comprising an aperture stop disposed closer to an object than the first and second transmissive reflective surfaces.

8. The optical system according to claim 1, wherein the following inequality is satisfied:
$$0.10 \leq LS 1 / L \leq 0.75$$
where LS1 is a distance on the optical axis between an aperture stop and one of the first and second transmissive reflective surfaces, which is disposed closer to an image plane, and L is a distance on the optical axis from an optical surface closest to an object in the optical system to the image plane.

9. The optical system according to claim 1, wherein the following inequality is satisfied:
$$1.5 \leq \vert Rhm / f \vert \leq 10.$$
where f isa focal length of the optical system, and Rhm is a radius of curvature of one of the first transmissive reflective surface and the second transmissive reflective surface, which has a smaller radius of curvature on the optical axis.

10. The optical system according to claim 1, wherein an effective area of at least one surface of an optical member disposed between an optical member closest to an object in the optical system and an optical member closest to an image plane in the optical system is flat.

11. The optical system according to claim 1, wherein the following inequality is satisfied:
$$0.05 \leq Lf / ( f \times FNo ) \leq 1.5$$
where f is a focal length of the optical system, FNo is an F-number of the optical system, and Lf is a distance on the optical axis between one of the first and second phase shifters, which is disposed closer to an image plane, and the image plane.

12. The optical system according to claim 1, wherein the following inequality is satisfied:
$$0.7 \leq FNo \leq 2.8$$
where FNo is an F-number of the optical system.

13. The optical system according to claim 1, wherein the following inequality is satisfied:
$$0.05 \leq Lhm / L \leq 0.45$$
where Lhm is a distance on the optical axis between the first transmissive reflective surface and the second transmissive reflective surface, and L is a distance on the optical axis from an optical surface closest to an object to an image plane.

14. The optical system according to claim 1, wherein the following inequality is satisfied:
$$1.5 \leq NL \leq 1.8$$
where NL is a refractive index for d-line of a lens having a curved surface in the optical system.

15. The optical system according to claim 1, wherein at least one of the first and second phase shifters is formed on a surface of an optical member, and
wherein the following inequality is satisfied:
$$0.1 \leq De / Dmax \leq 0.7$$
where De is an effective diameter of the surface, and Dmax is a maximum diameter of an area of the surface where the at least one of the first and second phase shifters is formed.

16. The optical system according to claim 1, wherein light incident on the optical system from an object side transmits through the first transmissive reflective surface, is reflected on the second transmissive reflective surface, is reflected on the first transmissive reflective surface, transmits through the second transmissive reflective surface, and reaches an image plane.

17. The optical system according to claim 1, wherein light incident on the optical system from an object side transmits through the second transmissive reflective surface, is reflected on the first transmissive reflective surface, is reflected on the second transmissive reflective surface, transmits through the first transmissive reflective surface, and reaches an image plane.

18. An image pickup apparatus comprising:
an optical system; and
an imaging element configured to capture an object image formed through the optical system,
wherein the optical system includes, in order:
a first transmissive reflective surface,
a first phase shifter,
a second transmissive reflective surface, and
a second phase shifter,
wherein the following inequalities are satisfied:
$$\vert Y / Rh 1 \vert \leq 0.2$$
$$\vert Y / Rr 1 \vert \leq 0.2$$
$$\vert Y / Rr 2 \vert \leq 0.2$$
where Rh1 is a radius of curvature on an optical axis of the first transmissive reflective surface, Rr1 is a radius of curvature on the optical axis of a surface on which the first phase shifter is provided, and Rr2 is a radius of curvature on the optical axis of a surface on which the second phase shifter is provided.
